(19) United States
(12) Patent Application Publication
(10) Pub. No.: US 2020/0010779 A1
(43) Pub. Date: Jan. 9, 2020

(54) DETERGENT COMPOSITION

(71) Applicant: HYPRED, DINARD (FR)

(72) Inventor: Anthony BAILLEUL, St Didier sous Riviere (FR)

(73) Assignee: HYPRED, DINARD (FR)

(21) Appl. No.: 16/472,391

(22) PCT Filed: Dec. 21, 2017
(86) PCT No.: PCT/FR2017/053797

§ 371 Date: Jun. 21, 2019

(30) Foreign Application Priority Data
Dec. 23, 2016 (FR) 16 63328

(51) Int. Cl. C11D 1/10; C11D 3/20; C11D 11/00; C11D 17/00

(52) U.S. Cl. CPC C11D 1/10; C11D 17/0008; C11D 11/0017; C11D 3/2093

(57) ABSTRACT

A composition that includes (i) one or more surfactants derived from a fatty acid and an amino acid and (ii) a solvent, and having a pH of 3.0 to 11.0. In the context of the present invention, the term “surfactant derived from a fatty acid and an amino acid” is understood to denote the molecules of formula (I),

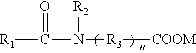

where R₁ is a C₈ to C₂₄ alkyl or alkenyl group; R₂ is —H, a C₁ to C₄ alkyl group, a phenyl group or —CH2COOM; R₃ is —C—R⁴₂; n is 1 to 4; R₄ is H, a C₁ to C₆ alkyl group or a C₁ to C₆ alkyl ester; and M is H or a cation, or a mixture thereof.

### TECHNICAL FIELD

The present invention relates to the field of detergent products. More particularly, the present invention relates to the field of industrial detergents, particularly in the area of feed and livestock farming. The present invention relates in particular to a composition, ready-to-use or concentrated, which has a high degree of stability at high temperatures and a relatively non-extreme pH.

### PRIOR ART

Detergent compositions used in industry sometimes need to respond to contradictory objectives in terms of their effectiveness and toxicity for users and the environment.

To obtain good results with regard to contamination it has been possible for a long time to use highly corrosive products (based specifically on caustic soda) with an extreme pH. However, said products are less and less compatible with environmental standards relating to effluent and are dangerous for those exposed to their use.

In order to replace the compositions of the prior art enzymatic solutions have been proposed which are able to decompose protein-based contamination. Said compositions are well known to a person skilled in art and are currently used in the field of domestic products such as laundry detergents.

However, enzymes, like all proteins, have a level of stability which is not very compatible with the conditions of use of an industrial detergent. They are in particular very sensitive to high temperatures such as those found in certain parts of the globe, which reduces their stability significantly and therefore their duration of use. Furthermore, the enzymes have respiratory sensitising properties which expose users to non-negligible risk.

There is therefore a need for detergent products which do not necessarily contain enzymes, which are mildly corrosive but still capable of processing protein-based contamination in professional industrial sectors, livestock farming, communities and domestic use.

Furthermore, said detergent products have to respect the environment and have to be disposable with waste water without prior treatment.

The present invention therefore proposes a detergent composition, ready-to-use or concentrated, which has a detergent effect equivalent to currently available detergent compositions, a non-extreme pH and increased stability.

### SUMMARY OF THE INVENTION

Thus the present invention relates in particular to a composition comprising: (i) one or more surfactants derived from a fatty acid and an amino acid and (ii) a solvent and having a pH of 3.0 to 11.0.

In the context of the present invention, the term “surfactant derived from a fatty acid and an amino acid” is understood to denote the molecules of formula (I),

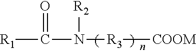

wherein R₁ is a C₈ to C₂₄ alkyl or alkenyl group; R₂ is —H, a C₁ to C₄ alkyl group, a phenyl group or —CH₂COOM; R₃ is —C—R⁴₂; n is 1 to 4; R⁴ is H, a C₁ to C₆ alkyl group or a C₁ to C₆ alkyl ester; and M is H or a cation or a mixture thereof.

In the context of the present invention, the term “ready-to-use” means that the said composition can be used in this state for cleaning.

In a preferred embodiment of the invention, a surfactant derived from a fatty acid and an amino acid is selected from a group comprising surfactants based on taurate, glutamate, alanine, alaninate, sarcosinate, aspartate and glycine.

According to a much preferred embodiment of the invention, said surfactant derived from a fatty acid and an amino acid is not sodium oleoyl sarcosinate.

According to a preferred embodiment of the invention, said surfactant derived from a fatty acid and an amino acid is selected from a group comprising potassium cocoyl taurate, potassium methyl cocoyl taurate, sodium caproyl methyl taurate, sodium cocoyl taurate, sodium lauroyl taurate, sodium methyl cocoyl taurate, sodium methyl lauroyl taurate, sodium methyl myristoyl taurate, sodium methyl oleoyl taurate, sodium methyl palmitoyl taurate, sodium methyl stearoyl taurate, dipotassium capryloyl glutamate, dipotassium undecylenoyl glutamate, disodium capryloyl glutamate, disodium cocoyl glutamate, disodium lauroyl glutamate, disodium stearoyl glutamate, disodium undecylenoyl glutamate, potassium capryloyl glutamate, potassium cocoyl glutamate, potassium lauroyl glutamate, potassium myristoyl glutamate, potassium stearoyl glutamate, potassium undecylenoyl glutamate, sodium capryloyl glutamate, sodium cocoyl glutamate, sodium lauroyl glutamate, sodium myristoyl glutamate, sodium olivoyl glutamate, sodium palmitoyl glutamate, sodium stearoyl glutamate, sodium undecylenoyl glutamate, cocoyl methyl B1 alanine, lauroyl 1-alanine, lauroyl methyl B-alanine, myristoyl B-alanine, potassium lauroyl methyl G alanine, sodium cocoyl alaninate, sodium cocoyl methyl B-alanine, sodium myristoyl methyl B alanine palmitoyl glycine, sodium lauroyl glycine, sodium cocoyl glycine, sodium myristoyl glycine, potassium lauroyl glycine, potassium cocoyl glycine, potassium lauroyl sarcosinate, potassium cocoyl sarcosinate, sodium cocoyl sarcosinate, sodium lauroyl sarcosinate, sodium myristoyl sarcosinate, sodium palmitoyl sarcosinate and mixtures thereof.

According to a preferred embodiment of the invention, said surfactant derived from a fatty acid and an amino acid is sodium lauroyl sarcosinate.

In the context of a preferred embodiment of the present invention, said solvent (ii) is selected from a group comprising glycerol, mono-propylene glycol and water. According to a preferred embodiment, said solvent (ii) is water. According to a preferred embodiment of the invention, said composition also comprises (iii) an ethoxylated triglyceride.

This last embodiment proposes a composition which is effective for two types of contamination to feed: proteins and lipids.

In the context of the present invention, the term “ethoxylated triglyceride” refers to triglycerides at least one of which, preferably two and more preferably three of their carbon chains of fatty acids, has been subjected to an ethoxylation reaction. According to a preferred embodiment of the invention, said ethoxylated triglyceride is derived from a triglyceride selected from a group comprising triglycerides of animal or vegetable origin and even more preferably from a group comprising lard, tallow, peanut oil, butter oil, cotton seed oil, linseed oil, olive oil, palm oil, grape seed oil, fish oil, soya oil, castor oil, rapeseed oil, copra oil and coconut oil. In the context of the present invention, the term derived means that said ethoxylated triglyceride has been obtained by an ethoxylation reaction of the cited triglyceride.

According to a much preferred embodiment of the invention, said ethoxylated triglyceride is derived from castor oil such as ethoxylated castor oil.

According to a preferred embodiment of the invention, said ethoxylated triglyceride comprises C8 to C30 carbon chains of fatty acid.

According to a preferred embodiment of the invention, said composition does not comprise enzymes.

In the context of the present invention, the term “does not comprise enzymes” means in particular that the ready-to-use composition according to the invention comprises less than 0.1% enzymes, preferably less than 0.04% enzymes and more preferably less than 0.01% enzymes. The present invention does not exclude compositions comprising traces of enzymes in the form of contaminations which do not exhibit significant activity.

In a preferred embodiment of the invention said ready-to-use composition also comprises one or more surfactants, one or more stabilisers, one or more rheological agents and one or more preservatives.

In an even more preferred embodiment of the invention said surfactant is cocamidopropyl betaine (CAPB).

According to a preferred embodiment of the invention, these other components represent an amount between 0.02 and 30 percent by mass relative to the total mass of said ready-to-use composition.

In a preferred embodiment of the invention, the term “comprises” means that the composition according to the invention comprises the components cited to the exclusion of any other component.

According to a preferred embodiment of the invention, the content of (i) is in an amount between 0.005 and 5 percent by mass relative to the total mass of said ready-to-use composition.

According to a preferred embodiment of the invention, the content of (ii) is in an amount between 70 and 99.97 percent by mass relative to the total mass of said ready-to-use composition.

According to a preferred embodiment of the invention, the content of (iii) is in an amount between 0.005 and 10 percent by mass relative to the total mass of said ready-to-use composition.

According to a preferred embodiment of the invention, components (i) and (iii) represent an amount which is between 0.01 and 15 percent by mass relative to the total mass of said ready-to-use composition.

According to a preferred embodiment of the invention, components (i), (ii) and (iii) represent an amount which is between 70 and 99.98 percent by mass relative to the total mass of said ready-to-use composition.

According to a preferred embodiment, the composition according to the invention is a liquid detergent for professional use.

The present invention also relates to a concentrated composition which comprises concentrations of (i) and (iii) which are greater than those in the ready-to-use composition according to the invention described above. According to a preferred embodiment said concentrated composition comprises concentrations of (i) and (iii) that are 2 times greater, more preferably 10 times greater and even more preferably 20 times greater than that of the ready-to-use composition according to the invention.

### DESCRIPTION OF EMBODIMENTS

The formulations presented below represent preferred examples, which are not restrictive in any way, of detergent compositions according to the invention.

Composition A (concentrated composition for 1% dilution):
sodium lauroyl sarcosinate: 2%
ethoxylated castor oil: 3%
other surfactants: 21.5%
other excipients: 2.5%
water: 71%

Composition B (ready-to-use composition):
sodium lauroyl sarcosinate: 0.02%
ethoxylated castor oil: 0.03%
other surfactants: 0.215%
other excipients: 0.025%
water: 99.71%

1-7. (canceled)

8. Liquid detergent for professional use, comprising:
(i) one or more surfactants derived from a fatty acid and an amino acid selected from a group comprising potassium cocoyl taurate, potassium methyl cocoyl taurate, sodium caproyl methyl taurate, sodium cocoyl taurate, sodium lauroyl taurate, sodium methyl cocoyl taurate, sodium methyl lauroyl taurate, sodium methyl myristoyl taurate, sodium methyl oleoyl taurate, sodium methyl palmitoyl taurate, sodium methyl stearoyl taurate, dipotassium capryloyl glutamate, dipotassium undecylenoyl glutamate, disodium capryloyl glutamate, disodium cocoyl glutamate, disodium lauroyl glutamate, disodium stearoyl glutamate, disodium undecylenoyl glutamate, potassium capryloyl glutamate, potassium cocoyl glutamate, potassium lauroyl glutamate, potassium myristoyl glutamate, potassium stearoyl glutamate, potassium undecylenoyl glutamate, sodium capryloyl glutamate, sodium cocoyl glutamate, sodium lauroyl glutamate, sodium myristoyl glutamate, sodium olivoyl glutamate, sodium palmitoyl glutamate, sodium stearoyl glutamate, sodium undecylenoyl glutamate, cocoyl methyl B1 alanine, lauroyl 1-alanine, lauroyl methyl B-alanine, myristoyl B-alanine, potassium lauroyl methyl G alanine, sodium cocoyl alaninate, sodium cocoyl methyl B-alanine, sodium myristoyl methyl B alanine palmitoyl glycine, sodium lauroyl glycine, sodium cocoyl glycine, sodium myristoyl glycine, potassium lauroyl glycine, potassium cocoyl glycine, potassium lauroyl sarcosinate, potassium cocoyl sarcosinate, sodium cocoyl sarcosinate, sodium lauroyl sarcosinate, sodium myristoyl sarcosinate, sodium palmitoyl sarcosinate and mixtures thereof, (ii) a solvent, (iii) an ethoxylated triglyceride derived from castor oil and having a pH between 3.0-11.0.

9. Liquid detergent for professional use according to claim 8, wherein it does not include enzymes.

10. Liquid detergent for professional use according to claim 8, wherein (i) is included in an amount between 0.005 and 5 percent by mass relative to the total mass of said composition.

11. Liquid detergent for professional use according to claim 8, wherein (iii) is included in an amount between 0.005 and 10 percent by mass relative to the total mass of said detergent.
